(19) United States
(12) Patent Application Publication
(10) Pub. No.: US 2003/0046350 A1
(43) Pub. Date: Mar. 6, 2003

(54) System for transcribing dictation

(75) Inventors: Madhu Chintalapati, Farmington Hills, MI (US); Raj Chintalapati, Farmington Hills, MI (US)

Correspondence Address: John S. Le Roy, Brooks & Kushman P.C., 1000 Town Center, 22nd Floor, Southfield, MI, 48075-1351, US

(73) Assignee: Systel, Inc., Southfield, MI

(21) Appl. No.: 09/946,303

(22) Filed: Sep. 4, 2001

(51) Int. Cl. G06F 15/16

(52) U.S. Cl. 709/206

(57) ABSTRACT

A seamless workflow solution for medical, legal and other transcription needs. Preferred embodiment includes ane or more server computers configured to (i) receive a dictation from a first communication device and (ii) output the dictation to a client computer, the computer configured to (i) play the dictation (ii) receive user input defining a transcription for the dictation and (iii) output the transcription to the server computer(s) wherein the server computer(s) and the client computer are configured to communicate such that dictation is not stored within persistent memory operably associated with the client computer.

### BACKGROUND OF THE INVENTION

1. Field of the Invention

The present invention relates generally to automated dictation transcription systems.

2. Background Art

A typical transcription business (Medical, Legal or other) in the US or in other parts of the world often involves transcribing huge volumes of voice jobs, with turn-around-times on an hourly basis, reliably and accurately. A transcription system in place should be reliable and scalable to provide a seamless workflow solution.

There are several dictation and transcription solutions in place today. However, none of these systems offer a simple and comprehensive solution to the transcription needs of the industry. The existing systems involve expensive software and proprietary hardware, thereby resulting in expensive maintenance. These systems are localized and require the users of the system to be either in a single location or at the best to be in different locations within the same country. These systems do not encapsulate the life cycle of a job (to be transcribed) into one entity, thereby resulting in multiple stages of transcription (involving transferring the voice files and the transcribed files back and forth), leading to inefficient workflow solutions and jeopardizing the confidentiality of the sensitive data. These systems also restrict the scope of the transcriptionist to a particular hospital or to a particular clinic or to a particular doctor, adding to the woes of the dearth of transcriptionists in US.

The advent of the Internet era has improved the quality of life of the people in many ways. However, the transcription industry was the slowest to adopt this technology. This calls for a transcription system that can make use of the connectivity benefits provided by the Internet to provide a simple, economical and an elegant solution to address the shortcomings of the existing transcription solutions.

### SUMMARY OF THE INVENTION

On objective of the present invention is to provide a seamless workflow solution for medical, legal and other transcription needs.

Another objective of the present invention is to provide a transcription system in compliance with the Health Insurance Portability and Accountability Act (HIPAA). For example, the present invention seeks to eliminate the need for storing dictation and transcription data in persistent storage associated with transcriptionists' computers. In addition, the present invention supports encrypted transmission of dictation and transcription data with the highest encryption readily available (i.e., 128 bit SSL).

A third objective of the present invention is to provide a transcription system in compliance with the American Association of Medical Transcriptionists (AAMT) regulations for medical transcriptionists. For example, the present invention includes online medical dictionaries and the pre-loading of transcription templates into the transcriptionists' text editor consoles. This feature allows transcriptionists to concentrate on the dictation rather than the spelling and formatting of the transcriptions, leaving less room for transcription errors.

To meet these objectives, features and advantages as well as additional objectives, features and advantages, preferred and alternate embodiments of a system for transcribing dictation are provided. The preferred system includes one or more server computers configured to (i) receive a dictation from a first communication device and (ii) output the dictation to a client computer, the computer configured to (i) play the dictation (ii) receive user input defining a transcription for the dictation and (iii) output the transcription to the server computer(s) wherein the server computer(s) and the client computer are configured to communicate such that dictation is not stored within persistent memory operably associated with the client computer.

The server computer(s) may be additionally configured to output the transcription in a predefined file format.

The server computer(s) may be additionally configured to receive demographic information associated with the dictation and output the demographic information to the client computer whereat the demographic information is automatically incorporated into the transcription.

The server computer(s) may be additionally configured to convert the dictation into text and output the text to the client computer whereat the text is displayed.

The server computer(s) may be additionally configured to output to the client computer a previously-transcribed transcription and receive input from the client computer containing at least one edit to the previously-transcribed transcription.

The server computer(s) may be additionally configured to output a template for the transcription to the client computer whereat the template receives the transcription according to a predefined format.

The server computer(s) may be additionally configured to spell-check the transcription at the client computer.

The server computer(s) may be additionally configured to output a status for the transcription indicating whether the transcription is complete, and if the transcription is complete, an accounting for the transcription, whether the transcription has been delivered and where the transcription has been delivered to.

The system may include a plurality of client computers each configured to play and receive input transcribing a plurality of dictations wherein the server computer(s) are additionally configured to spool a particular dictation to particular client computer based on a spooling algorithm.

The spooling algorithm may be configured to rank a plurality of transcriptionists based on a total number of transcriptions each transcriptionist has completed for an author of a dictation to be transcribed and cause the server computer(s) to spool the dictation to be transcribed to the client computer operated by the transcriptionist having the highest rank for the author.

The spooling algorithm may be configured to rank a plurality of transcriptionists based on each transcriptionist's quality of past transcription(s) for an author of a dictation to be transcribed and cause the server computer to spool the dictation to be transcribed to the client computer operated by the transcriptionist having the highest rank for the author.

The system may be implemented over a computer network including the Internet.

The system may be configured such that for each dictation, only one transcription is maintained on the server computer. The system may be configured such that a particular dictation or transcription is output to a single client computer at any given time.

Communication between the server computer(s) and the client computer or communication between the server computer(s) and the first communication device may be encrypted.

The server computer(s) may be additionally configured to output the transcription to a second communication device. Communication between the server computer(s) and the second communication device may be encrypted.

The system may additionally include a plurality of client computers each configured to play and receive input transcribing a plurality of dictations wherein the server computer(s) and client computers are additionally configured to support communication of messages among at least two client computers.

The client computer may be additionally configured to receive input from a peripheral player control device for controlling playback of the dictation. The peripheral player control device may include a foot pedal.

The above objects and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a schematic diagram illustrating a system 10 in accord with a preferred embodiment of the present invention;

FIG. 2 illustrates one embodiment 34 of a graphical user interface (GUI) for transcribing a dictation file 18 in accord with the present invention;

FIG. 3a illustrates an example GUI configured to provide a hospital office administrator (i.e., Venkat) with a variety of service/status information corresponding to transcribed and pending dictations;

FIG. 3b, illustrates an example GUI containing more detailed service/status information corresponding to one of the customer locations listed in FIG. 3a (i.e., Super Specialty Hospital);

FIG. 3d illustrates an example GUI containing more detailed service/status information corresponding to a particular person providing dictation to be transcribed (i.e., Vijaya Lakshmi).

FIG. 3c, illustrates an example GUI containing more detailed service/status information corresponding to one of the customer location departments listed in FIG. 3b (i.e., pathology); and

### DETAILED DESCRIPTION OF THE PREFERRED EMBODIMENTS

One embodiment of the present invention comprises an Internet based central server arrangement that collects “voice jobs” (i.e., dictation to be transcribed) from the authors (doctors, attorneys, professors etc.), allows the transcriptionists to transcribe the voice jobs, allows the editors to edit the transcribed jobs and allows the delivery of the edited jobs back to the authors in the required format, without the users ever transferring any files between any two locations. The system handles transferring the data (both voice and transcription) between each location in a manner completely transparent to the users. All this functionality is achieved by employing advanced Internet technologies like multimedia-streaming, file transfer protocols (e.g. FTP), and highly encrypted data transfers (e.g. 128 bit SSL), etc., in conjunction with a server based technology.

In a preferred embodiment of the present invention, the transcription system comprises a web server that is capable of importing voice files from the authors in several different ways (dial-in through telephones, automated FTP services to the authors' locations etc). Thereafter, the server checks for the presence of currently logged-in transcriptionists in the system and intelligently assigns these voice jobs to the most capable transcriptionists based on certain pre-determined criteria.

The Internet based server technology allows the transcriptionists to be present at their desired locations. The transcriptionists can listen to the voice jobs on their desktop computers with Internet connection through audio streaming, thereby eliminating the need for the server to send the voice job physically to each transcription location. In accord with a preferred embodiment, software is downloaded to the transcriptionists' computer when they login for the first time, thereby providing the transcriptionists with a text editor to transcribe the voice job and an audio stream player to listen to the voice job. It is also preferred that this software allows the transcriptionists to control the audio stream player through a foot-pedal, thereby adding to the convenience of the transcriptionists while typing the job.

When the transcriptionists are finished typing a job, the system allows the transcriptionists to transfer the typed data back to the web server by the click of a button. Notably, throughout this process, neither the streamed voice nor the typed data resides on any persistent memory on the transcriptionist computer. All this data resides in the volatile memory of the transcriptionists' desktop computer and gets cleared as soon as the transcriptionist is done transcribing the voice job.

In further accord with the preferred embodiment, transcription editors enjoy the same functionality as the transcriptionists, but have the added privilege of rating the transcription quality, which in turn is used by the system to build the transcriptionist profile over time to be used against assigning the jobs to the transcriptionists in the future.

The delivery mechanism for the jobs that have successfully passed the editing stage is completely automated and the system supports several common delivery options like e-mail, fax, FTP, network printing etc. with several different industry standard delivery formats like text files, pdf, html, word, word perfect etc.

The authors can access this system on the Internet both to submit new jobs as well as to view the status of the submitted jobs.

The system administrators can administer this system completely through the Internet (generate reports, generate invoices for authors, generate the amounts to be paid to the transcriptionists and editors, assign and re-assign jobs to the transcriptionists and editors, override the system decisions if necessary, track the status of each job etc.).

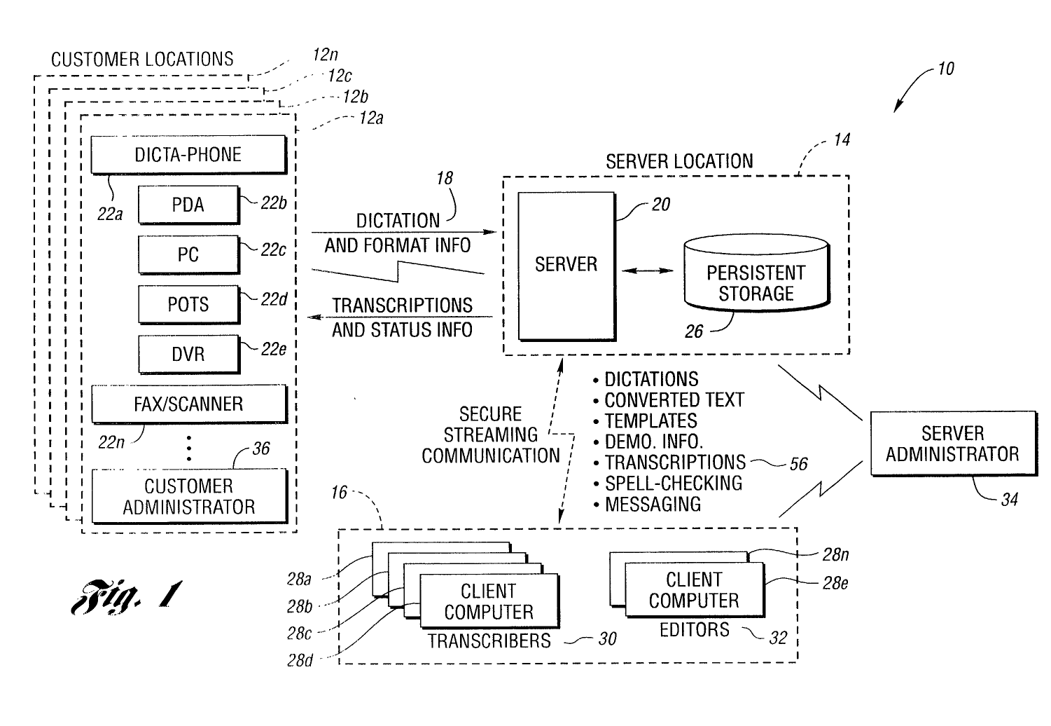

FIG. 1 is a schematic diagram illustrating a system 10 in accord with a preferred embodiment of the present invention. Notably, the particular elements shown in FIG. 1, the interaction thereof and the arrangement thereof may be substituted or adapted within the scope of the present invention to best suit a particular set of circumstances.

System 10 comprises a plurality of customer locations 12a-12n, a server location 14 and a transcription location 16. Dictation files 18 originate at the customer locations 12 and are communicated to the server location 14. Server 20 at the server location 14 is in operable communication with the customer locations 12 and configured to receive dictation files 18.

At each customer location 12a-12n, dictation files 18 may originate from any one or more of a plurality of communication devices 22a-22n including but not limited to dicta-phone telephone, Lanier, DVI, personal or networked computer, personal data assistant (PDA), facsimile/scanner, digital voice recorder (DVR), cassette tapes etc.

Operable communication established between communication devices 22 at the customer locations 12 and the server 20 includes any one or more of, but is not limited to plain-old-telephone-service (POTS), computer telephony, a local area network (LAN), a wide area network (WAN), the Internet, email, dial-up, FTP, telnet, etc. In accord with a preferred embodiment of the present invention communication between customer locations 12 and server 20 is encrypted upon client login. A suitable encryption algorithm includes a secure socket layer (SSL) communication protocol.

In accord with a preferred embodiment of the present invention, dictation files 18 are stored electronically in an audio file format (e.g., .midi, .truespeech, vox, .wav, .mpg, mp3 etc.), at the customer locations 12 and communicated to the server 20 by one of the means of communication mentioned in the above paragraph. Transmission of an audio dictation file from the customer location may be initiated by either the server 20 or the communication device 22. Additionally, demographic information associated with each dictation file 18 may be communicated to server computer 20 contemporaneous with or separate from the corresponding audio file transfer.

Server computer 20 possesses or is operably associated with persistent storage 26. In accord with a preferred embodiment of the present invention, the server 20 stores the dictation files 18 and associated demographic and format information in persistent storage 26. Additionally, server 20 is configured to populate a database of service data for each customer location 12 including but not limited to: customer contact information, terms of service information, customer billing information including account balance and status, total number of dictations transcribed, number of dictations currently being transcribed, number of transcribers online, demographic information of the jobs, number of pending dictations to be transcribed, transcription receipt and delivery information including date, source and destination etc. As discussed in greater detail below, server 20 is configured to provide customer locations 12 with one or more elements of the above service data in real-time.

Transcription location 16 comprises a plurality of client computers 28a-28n. Preferably, a subset of client computers (e.g., 28a-28d) are each operated by a transcriber 30a-30d for transcribing dictation files 18 stored within persistent storage 26. The remaining client computers (e.g., 28e-28n) are each operated by an editor 32 editing a transcription previously generated by a transcriber 30.

Server administrators 34 perform administrative functions including manual job assignment. Customer administrators 36 monitor real time status checks and billing information.

In accord with a preferred embodiment of the present invention, communication established between the server computer 20 and the client computers 28a-28n is configured such that dictation audio files 18 may be transcribed by transcribers 30 and edited by editors 32 without storing the dictation files 18 within the persistent storage (not shown) associated with the client computers 28a-28n. A preferred method for doing so involves configuring the server computer 20 and the client computers 28a-28n to communicate and process data (i.e., transcribe and edit the audio files 18) according to a streaming communication format in which, the dictation data transmitted to the client computers 28a-28n resides only in volatile random access memory (RAM) storage during the transcription and the editing phases.

In further accord with a preferred embodiment of the present invention, file routing of the dictation audio files 18 to the transcribers 30 and editors 32 will be done automatically using intelligent algorithms.

Communication between the server 20 and the client computers 28a-28n is encrypted upon authorized client login. A suitable encryption algorithm includes a secure socket layer (SSL) communication protocol with 128 or more bits of encryption.

Suitable client computer applications configured to communicate streaming data between server 20 and client computers 28a-28n include World Wide Web browsers including but not limited to Netscape® Navigator 4.7 and above and Microsoft® Internet Explorer 5.0 and above. A suitable application for developing interactive applications for playing, processing and otherwise transmitting streaming data includes streaming services residing on the server 20. Notably, configuring client-server computer arrangements to communicate based on a streaming media format is well understood by persons of ordinary skill in the field of information technology and application development.

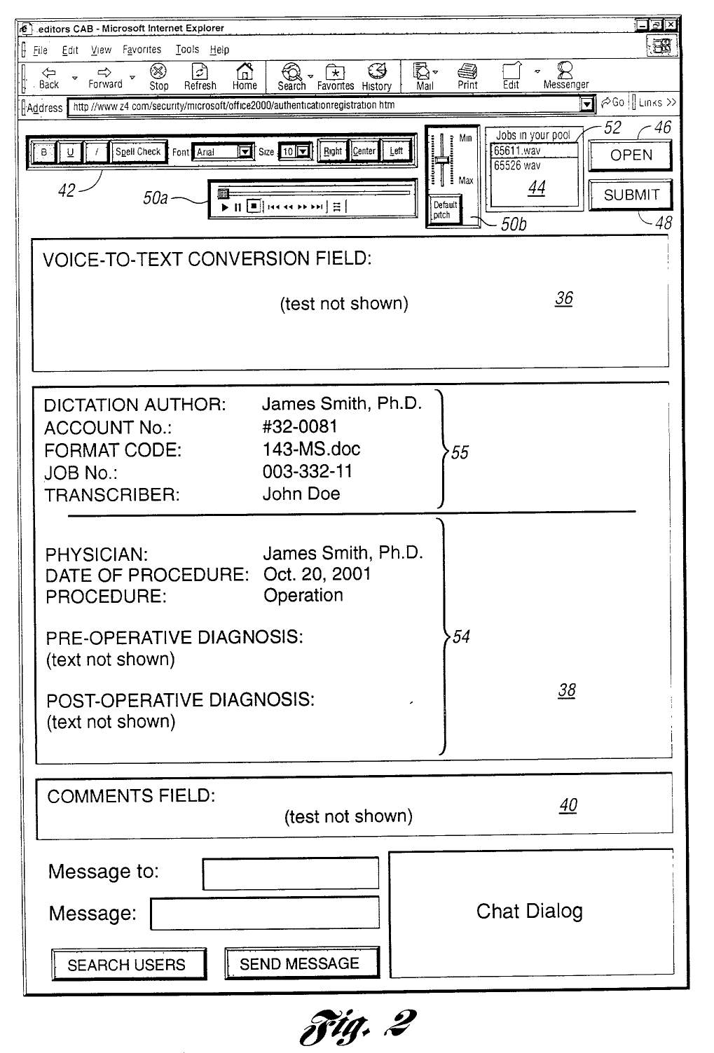

FIG. 2 illustrates one embodiment 34 of a graphical user interface (GUI) for transcribing a dictation file 18 in accord with the present invention. GUI 34 comprises a voice recognition output field 36, a transcription template field 38, a comment field 40, a plurality of formatting buttons 42, a messaging utility 43, a dictation file pool 44 including open and submit buttons 46 and 48 respectively and dictation player controls 50a and 50b.

When a transcriber 30 operating his or her client computer 28a-28d logs into server 20 (login not shown), dictation file pool 44 is automatically populated with a selectable link 52 to one or more dictation files 18 residing within persistent storage 26 associated with server 20. To begin transcribing a dictation, the transcriber selects a link 52 corresponding to a particular dictation (e.g., “65526.wav”) and selects the “Open” button 46.

In accord with a preferred embodiment of the present invention, the server computer 20 is configured to automatically convert audio dictation files 18 into a text format based on a voice recognition algorithm. Existing voice recognition algorithms suitable for such use include (Dragon Naturally Speaking, IBM Via Voice, Phillips Speech Magic etc.). The voice dictation files 18 are passed through the voice recognition system on server 20 to generate the text to be stored in the persistent storage 26. Over time, the voice recognition system adapts itself to the speaker's voice to reduce the percentage of errors in the voice-to-text conversion. The dictation player control has the necessary software to interact with the serial port, thereby supporting any foot pedal connected to the serial port.

Upon selecting the “Open” button 46, the voice recognition output field 36 is automatically populated, in a streaming fashion, with the results of the automatic voice-to-text conversion. Additionally, a format template 54 associated with the dictation is automatically integrated into the transcription template field 38. If demographic information 55 (e.g., name, account number, date, etc.) is associated with the selected dictation, the demographic information is also automatically input into the transcription template field 38.

The results of the automatic voice-to-text conversion contained within the voice recognition output field 36 are intended to assist the transcriber in efficiently generating an accurate transcription of the selected dictation within the transcription template field 38. Accordingly, the transcriber may copy the entire voice-to-text conversion, portions of the conversion, or none of the conversion into transcription template field 38.

Dictation player controls 50a provide a transcriber with functionality to play and replay portions of the selected dictation so the transcriber may efficiently transcribe the dictation. Notably, playing or replaying a portion of the selected dictation causes the server computer 20 to provide the transcriber's client computer with the portion in a streaming format such that the portion played is never stored in persistent storage associated with the transcriber's client computer. A pitch control 50b allows a transcriber to adjust the speed at which the selected dictation is played. A volume control allows the user to control the volume of playback of the recorded messages. A foot pedal (not shown) attached to the client computer 16 allows the transcribers 30 and the editors 32 to control the player (instead of the keyboard and the mouse) to facilitate ease of transcription. The foot pedal doesn't require the client computer to install any additional software. The foot pedal connects to the client computers 30 and 32 through the serial ports on the client computers. Any brand of foot pedal can be used and the system doesn't restrict the users to any proprietary foot pedals.

Comment field 40 allows a transcriber to input his or her comments regarding the active dictation or transcription. As discussed in more detail below, a transcription editor may review the contents of comment field 40 when editing the transcription. The comments are tightly integrated into the dictation. When the transcription editor clicks on one of these comments, the dictation player will automatically start playing that portion of the dictation for which the comments are made.

The spell check feature associated with formatting buttons 42 allows a transcriber to execute a spell-check operation on any text input into the transcription template field 38. For each word not found in a spell-check database of correct spellings, a spell-check pop-up window (not shown) provides a plurality of correct spellings for words similar to the unrecognized word. In response to the pop-up, the user may select a provided word to replace the unrecognized word, input a unique spelling for the unrecognized word, ignore the unrecognized word, or add the unrecognized word to the spell-check database of correct spellings. In accord with a preferred embodiment of the present invention, the spell-check function and the associated database of correct spellings is hosted by the server 20.

Messaging utility 43 enables a transcriber to interactively communicate via relay chat (i.e., instant messaging) with other transcribers or editors currently logged into server 20. For instance, a transcriber in India could interactively chat with an editor in the United States to verify the correct spelling of a particular word. Messaging utility 43 comprises a “message to:” field for inputting the recipient of the message, a “message” field for inputting a message to send to the recipient, a “send message” button for sending the input message, a “search users” for searching the potential message recipients currently logged into server 20, and a dialog field for outputting a dialog between sender and recipient.

Upon completing the transcription within the transcription template field 38, the transcriber selects the “Submit” button 48 to transmit the transcription 56 (and associated comments), in a streaming format, to the server computer 20. At server computer 20, the transcription is stored in persistent memory 26 in an RTF format.

Similar to the transcriber's GUI 34 illustrated in FIG. 2, an editor's GUI (not shown) is provided to allow an editor 32 to review and edit a previously-transcribed transcription 56. In accord with a preferred embodiment of the present invention, the editor's GUI is substantially similar in form and function to the transcriber GUI illustrated in FIG. 2, except for a lacking voice recognition output field 36. Both of the GUI's are designed to be very intuitive to a non-technical user.

Neither the transcriber's GUI nor the editor's GUI require any manual installation of the client software onto the transcribers' or the editors' computers. The server computer 20 automatically initiates the remote installation process.

In accord with a preferred embodiment of the present invention, server 20 is configured to execute one or a combination of spooling algorithms to allocate dictation and transcription files to the respective dictation file pools 44 of each transcriber 30 and editor 32. One spooling algorithm ranks transcribers and editors according to the total number of dictations they have transcribed and edited, respectively, for a particular author of a dictation to be transcribed. Based on the rank, the dictation and corresponding transcription is spooled to the dictation file pool 44 of the transcriber and editor, respectively, who are logged in and have the highest rank at the time of spooling. Another spooling algorithm ranks transcribers and editors based on the overall quality of their previous transcriptions. Indicators of quality might include accuracy, punctuation and timeliness. Notably, a hybrid spooling algorithm may be implemented as a combination of one or more spooling algorithms. Additionally, a wide variety of ranking and spooling criteria in addition to the criteria herein discussed may be implemented in accord with this aspect of the present invention.

In accord with a preferred embodiment of the present invention, the server 20 is configured to grant only one client computer 28a-28n, whether operated by an editor or transcriber, access to a particular dictation file 18 or transcription file 56 at any given time. Additionally, server 20 is configured to output transcription files 56 to the customer locations 12 in one or more of a plurality of formats including but not limited to “.doc”, “.wp”, “.xls”, “.pdf”, e-mail text, e-mail file attachment, facsimile, etc. Transcription files 56 may be output to the customer locations 12 automatically upon completion, periodically, or upon customer request through various means of delivery like e-mail, FTP, fax, print and other custom upload formats.

In an alternate embodiment of the present invention, customer location 12 incorporates server location 14 such that the transcription location 16 receives dictation data directly from, and returns transcription data directly to, the customer location 12 in a streaming format.

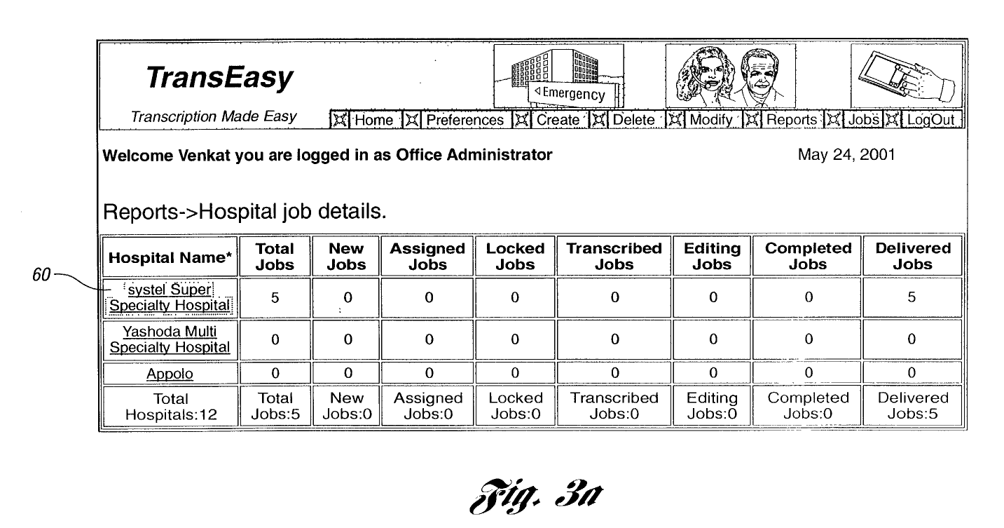

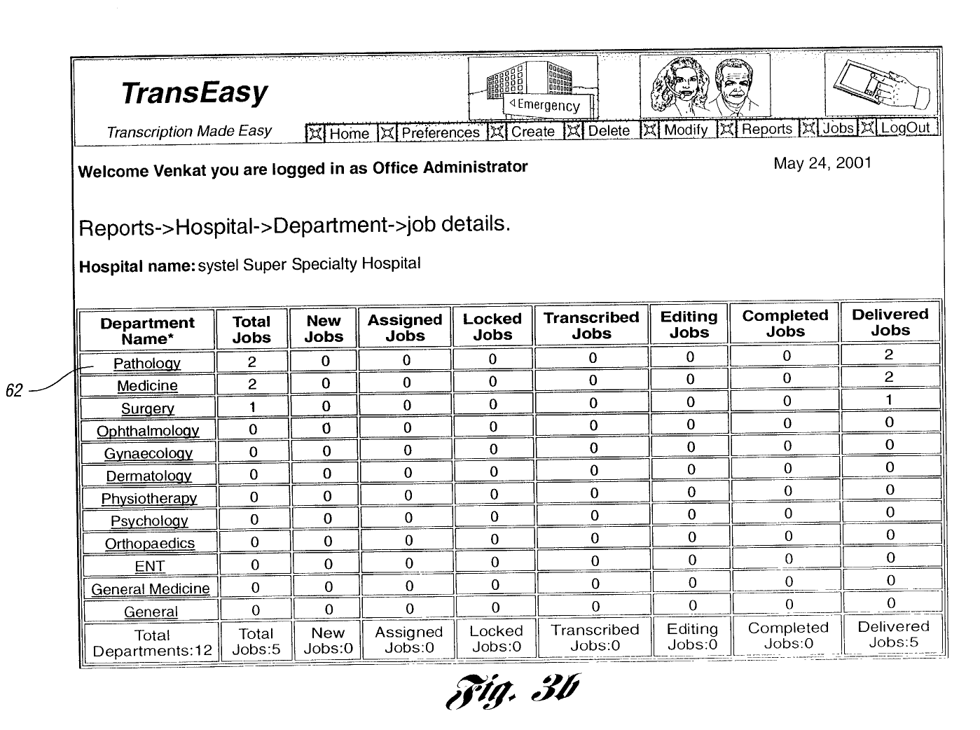

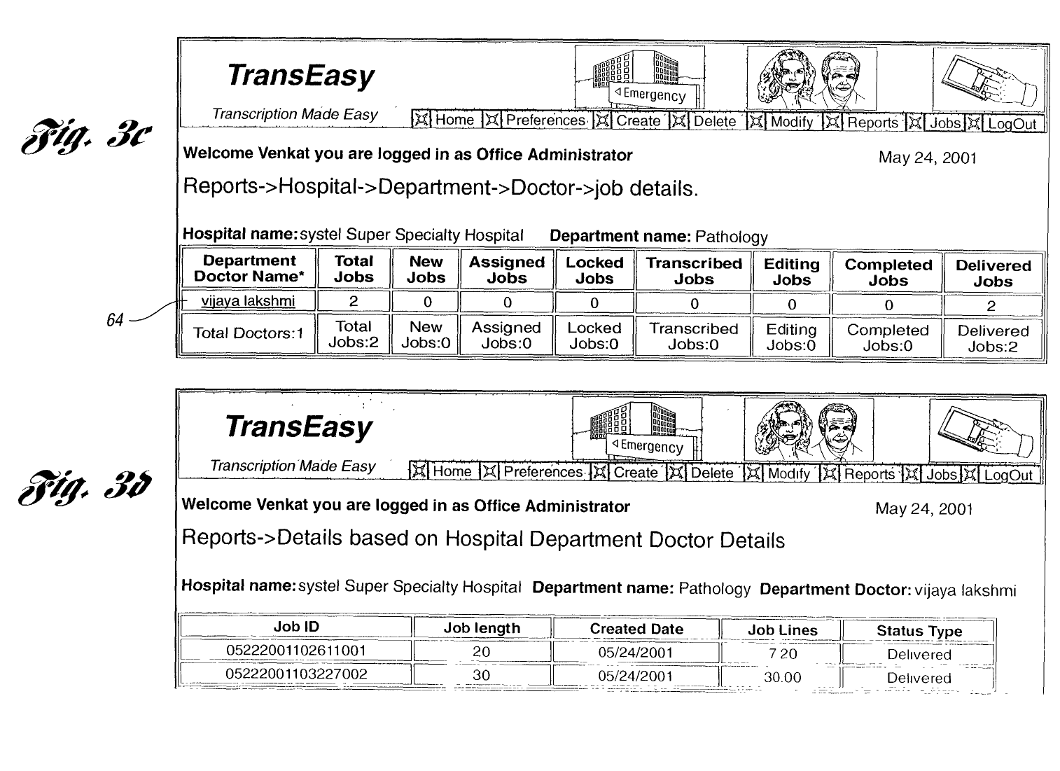

FIGS. 3a-3d illustrate example graphical user interfaces (GUIs) for reporting service/status information to the customer locations 12. In accord with a preferred embodiment of the present invention, authorized persons at customer locations 12 securely access their respective service/status information GUI(s) via the Internet upon login to server 20. FIG. 3a illustrates an example GUI configured to provide a hospital office administrator (i.e., Venkat) with a variety of service/status information corresponding to transcribed and pending dictations. Notably, the GUIs illustrated in FIGS. 3a-3d may be configured within the scope of the present invention to provide and report service/status information for a plurality of industries including but not limited to healthcare services, legal services, etc.

As illustrated in FIG. 3a, status information provided to an office administrator includes but is not limited to, for each of a plurality of customer locations (i.e., hospitals), the total number of transcription jobs in queue, the number of new (i.e., un-transcribed jobs), the number of assigned jobs, the number of locked jobs, the number of transcribed jobs, the number of editing jobs, the number of completed jobs, and the number of delivered jobs. A hyperlink 60 allows a user to view more detailed service/status information for a particular customer location.

Referring now to FIG. 3b, an example GUI containing more detailed service/status information corresponding to one of the customer locations listed in FIG. 3a (i.e., Super Specialty Hospital) is provided. According to the example, status information provided in FIG. 3b is substantially similar to that provided in FIG. 3a, but output according to customer location department (i.e., hospital department). A hyperlink 62 allows a user to view more detailed service/status information for a particular department (i.e., pathology) of the current customer location (i.e., Super Specialty Hospital).

Referring now to FIG. 3c, an example GUI containing more detailed service/status information corresponding to one of the customer location departments listed in FIG. 3b (i.e., pathology) is provided. According to the example, status information provided in FIG. 3c is substantially similar to that provided in FIG. 3a, but output according to persons providing dictation to be transcribed. A hyperlink 64 allows a user to view more detailed service/status information for a particular person providing dictation to be transcribed (i.e., Vijaya Lakshmi).

Referring now to FIG. 3d, an example GUI containing more detailed service/status information corresponding to a particular person providing dictation to be transcribed (i.e., Vijaya Lakshmi) is provided. According to the example, status information provided in FIG. 3d includes but is not limited to job ID, job length, created date, job lines, and status type.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for transcribing dictation, the system comprising:
one or more server computers configured to:
receive a dictation from a first communication device; and
output the dictation to a client computer; and
at least one client computer configured to:
play the dictation;
receive user input defining a transcription for the dictation; and
output the transcription to the server computer(s);
wherein the server computer(s) and the client computer(s) are configured to communicate such that dictation is not stored within persistent memory operably associated with the client computer(s).

2. The system of claim 1 wherein the server computer is additionally configured to output the transcription in a predefined file format.

3. The system of claim 1 wherein the server computer is additionally configured to receive demographic information associated with the dictation and output the demographic information to the client computer whereat the demographic information is automatically incorporated into the transcription.

4. The system of claim 1 wherein the server computer is additionally configured to convert the dictation into text and output the text to the client computer whereat the text is displayed.

5. The system of claim 1 wherein the server computer is additionally configured to output to the client computer a previously-transcribed transcription and receive input from the client computer containing at least one edit to the previously-transcribed transcription.

6. The system of claim 1 wherein the server computer is additionally configured to output a template for the transcription to the client computer whereat the template receives the transcription according to a predefined format.

7. The system of claim 1 wherein the server computer is additionally configured to spell-check the transcription at the client computer.

8. The system of claim 1 wherein the server computer is additionally configured to output a status for the transcription indicating whether the transcription is complete, and if the transcription is complete, an accounting for the transcription, whether the transcription has been delivered and where the transcription has been delivered to.

9. The system of claim 1 additionally comprising a plurality of client computers each configured to play and receive input transcribing a plurality of dictations wherein the server computer is additionally configured to spool a particular dictation to particular client computer based on a spooling algorithm.

10. The system of claim 9 wherein the spooling algorithm is configured to:
rank a plurality of transcriptionists based on a total number of transcriptions each transcriptionist has completed for an author of a dictation to be transcribed; and
cause the server computer to spool the dictation to be transcribed to the client computer operated by the transcriptionist having the highest rank for the author.

11. The system of claim 9 wherein the spooling algorithm is configured to:
rank a plurality of transcriptionists based on each transcriptionist's quality of past transcription(s) for an author of a dictation to be transcribed; and
cause the server computer to spool the dictation to be transcribed to the client computer operated by the transcriptionist having the highest rank for the author.

12. The system of claim 1 wherein the system is implemented over a computer network.

13. The system of claim 1 wherein for each dictation, only one transcription is maintained on the server computer.

14. The system of claim 13 wherein a particular dictation or transcription is output to a single client computer at any given time.

15 The system of claim 1 wherein communication between the server computer and the client computer or communication between the server computer and the first communication device is encrypted.

16. The system of claim 1 wherein the server computer is additionally configured to output the transcription to a second communication device.

17. The system of claim 16 wherein communication between the server computer and the second communication device is encrypted.

18. The system of claim 1 additionally comprising a plurality of client computers each configured to play and receive input transcribing a plurality of dictations wherein the server computer and client computers are additionally configured to support communication of messages among at least two client computers.

19. The system of claim 1 wherein the client computer is additionally configured to receive input from a peripheral player control device for controlling playback of the dictation.

20. The system of claim 19 wherein the peripheral player control device comprises a foot pedal.

21. A system for transcribing dictation, the system comprising:
at a server computer device:
a means for receiving a dictation from a communication device; and
a means for outputting the dictation to a client computer device; and
at a client computer device:
a means for playing the dictation;
a means for defining a transcription for the dictation; and
a means for outputting the transcription to the server computer device wherein the server computer device and the client computer device are configured to communicate such that the dictation is not stored within persistent memory operably associated with the client computer.
